(19) United States
(12) Patent Application Publication
(10) Pub. No.: US 2003/0060076 A1
(43) Pub. Date: Mar. 27, 2003

(54) Ultrasonic welded telsplice stick

(76) Inventors: James A. Powell, Winston-Salem, NC (US); Alexander Nestor, Winston-Salem, NC (US); David Erb, Harrisburg, PA (US); Leo Schuppert JR., York, PA (US)

Correspondence Address: Tyco Electronice Corporation, 4550 New Linden Hill Road, Suite 450, Wilmington, DE, 19808-2952, US

(21) Appl. No.: 09/963,720

(22) Filed: Sep. 26, 2001

(51) Int. Cl. H01R 4/24

(52) U.S. Cl. 439/403

(57) ABSTRACT

A telsplice stick device adapted to connect at least two electrical cables is provided. The telsplice connector includes a plurality of connectors, where each connector has opposing sides. At least one of the opposing sides of one connector is removably connected to one of the opposing sides of another connector by an ultrasonic weld. A crimping device is used with the telsplice stick, where the telsplice stick is inserted into the crimping device. At least one, but generally two or more cables are inserted into the telsplice connectors in the telsplice stick and spliced together.

### RELATED APPLICATIONS

[Not Applicable]

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

Certain embodiments of the present invention relate to telsplice connectors and more particularly to telsplice connectors joined together using ultrasonic welding to form a telsplice stick.

Plug-in circuit boards with electronic components thereon are widely used in the telecommunication and computer industries, among other industries. Generally, high speed data signals are conveyed to and from the circuit boards at a desired data rate using electrical cabling, wiring, connections or any other connection pathway (generally designated herein as “cable or cabling”).

Joining individual cables together (commonly known as “splicing”) is well known in the art. It is known to join, screw, clamp, compress or crimp the connectors onto the cable ends to join the cables. The cables are manually inserted onto the connecter and then the connector is screwed or crimped onto the cables generally using a tool such as a pair of pliers. Crimping tools are currently available that enable individual telsplice connectors to be individually inserted into the crimping tool before the cables are inserted into the telsplice connector. The crimping tool is manipulated so that telsplice connector is crimped onto the cables. It should be appreciated that this procedure is wasteful, costly and time intensive.

Different ideas have been employed to improve the splicing process. One idea includes using a semi-automatic crimping tool with a cartridge. Individual telsplice connectors are loaded into the cartridge and the cartridge is fed into the semi-automatic crimping tool. It should be appreciated that this procedure is again time intensive, requiring time to load the individual telsplice connectors into the cartridge. Further, this idea requires an additional cost to purchase the cartridge. Alternatively, the cartridges could be sold already loaded with telsplice connectors. It should be appreciated that, if the cartridge is removed before a whole sleeve of telsplice connectors are used, connectors may be lost.

Another approach includes loading telsplice connectors onto a tape, wherein the tape and connectors are inserted into the crimping tool. Loading individual connectors onto a tape is costly and time intensive. Furthermore, the tape may jam the crimping tool, again affecting work time and possibly damaging the machine.

It is desirable to provide a method for forming connectors that are removably connected. It is also desirable to provide connectors that are joined in a removable or breakable manner.

It is an object of at least one embodiment of the present invention to meet the foregoing needs and other objectives, which will become apparent from the detailed description, drawings and claims presented hereafter.

### BRIEF SUMMARY OF THE INVENTION

In accordance with one embodiment of the present invention, a telsplice stick device adapted to connect at least two electrical cables is provided. The telsplice connector includes a plurality of connectors, where each connector has opposing sides. At least one of the opposing sides of one connector is removably connected to one of the opposing sides of another connector by an ultrasonic weld. A crimping device is used with the telsplice stick, where the telsplice stick is inserted into the crimping device. At least one, but generally two or more cables are inserted into the telsplice connectors in the telsplice stick and spliced together.

In accordance with another embodiment of the present invention, a method of forming a telsplice stick is provided. A plurality of connectors are formed, each connector having a nonconductive housing and at least two opposing sides. Each of the connectors is removably connected to an adjacent connector using an ultrasonic weld.

In yet another embodiment, a method of telsplicing electric cabling is provided. One end of at least one electric cable is inserted into a channel defined by at least one of a plurality of telsplice connectors forming a telsplice stick. The at least one telsplice connector is separated from the telsplice stick using a tool.

Further limitations and disadvantages of conventional and traditional approaches will become apparent to one of skill in the art, through comparison of such systems with the present invention as set forth in the remainder of the present application with reference to the drawings.

### BRIEF DESCRIPTION OF SEVERAL VIEWS OF THE DRAWINGS

The foregoing summary, as well as the following detailed description of the embodiments of the invention, will be better understood when read in conjunction with the appended drawings. For the purpose of illustrating the invention, there is shown in the drawings, embodiments which are preferred. It should be understood, however, that the present invention is not limited to the precise arrangements and instrumentality shown in the attached drawings.

FIG. 1 illustrates a back elevational view of a telsplice connector formed in accordance with one embodiment of the present invention.

FIG. 2 illustrates a side elevational view of the telsplice connector of FIG. 1 formed in accordance with one embodiment of the present invention.

FIG. 3 illustrates a front elevational view of the telsplice connector of FIG. 1 formed in accordance with one embodiment of the present invention.

FIG. 4 illustrates a front elevational view of a second telesplice connector formed in accordance with one embodiment of the present invention.

FIG. 5 illustrates an elevational cross-sectional view of the telsplice connector of FIG. 4 taken along line V-V of FIG. 4.

FIG. 6 illustrates a front elevational view of a third telesplice connector formed in accordance with one embodiment of the present invention.

FIG. 7 illustrates an elevational cross-sectional view of the telsplice connector of FIG. 6 taken along lines VII-VII.

FIG. 8 illustrates a back elevational view of a telsplice stick formed in accordance with one embodiment of the present invention.

FIG. 9 illustrates an enlarged partial view of the telsplice stick of FIG. 8 formed in accordance with one embodiment of the present invention.

### DETAILED DESCRIPTION OF THE INVENTION

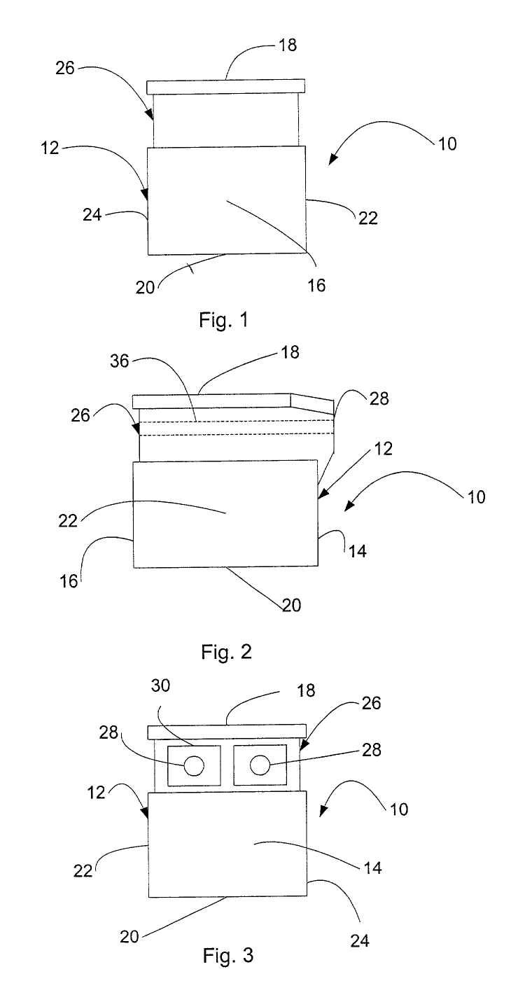

FIGS. 1 and 2 illustrate one embodiment of an individual telsplice connector formed in accordance with one embodiment of the present invention. In this illustrated embodiment, the telsplice connector, generally designated 10, has a housing 12 having opposing first and second engagement surfaces 14 and 16, respectively, opposing upper and lower surfaces 18 and 20, respectively, and opposing side surfaces 22 and 24, respectively. In one embodiment, the first and second engagement surfaces 14 and 16 define a first pair of planes and the upper and lower surfaces 18 and 20 define a second pair of planes perpendicular to the first pair of planes. Furthermore, the side surfaces 22 and 24 define a third pair of planes that are perpendicular to both the first and second pair of planes.

It should be appreciated that the terms upper, lower, front, back and side are designations used for discussion purposes only. These terms are assigned to distinguish surfaces on one plane of the telsplice connector from the surfaces on other planes. These terms are independent of the orientation of the telsplice connector. It is also appreciated that while a particular number of joined telsplice connectors are illustrated and discussed, any number of telsplice connectors is contemplated. Further, while the present invention is discussed with respect to a telsplice connector, any connector is contemplated.

FIGS. 1 and 2 also illustrate a crimping portion 26, which is adapted to engage a crimping device (not shown) enclosed in housing 12 discussed in greater detail below. In one embodiment, the crimping portion 26 is joined to and integral with upper surface 18 and adapted to move within housing 12 to engage the crimping device.

FIG. 3 illustrates the housing 12 defining at least one opening 28 in engagement surface 14. In particular, in one embodiment the crimping portion 26 defines two openings 28, having generally rectangular indents 30, which fluidly communicate with an interior channel 36 (shown in phantom in FIG. 2) as discussed below. The openings 28 are adapted to receive the electrical cables for securing and crimping therein. It should be appreciated that, while only two openings are illustrated, any number of openings 28 are contemplated.

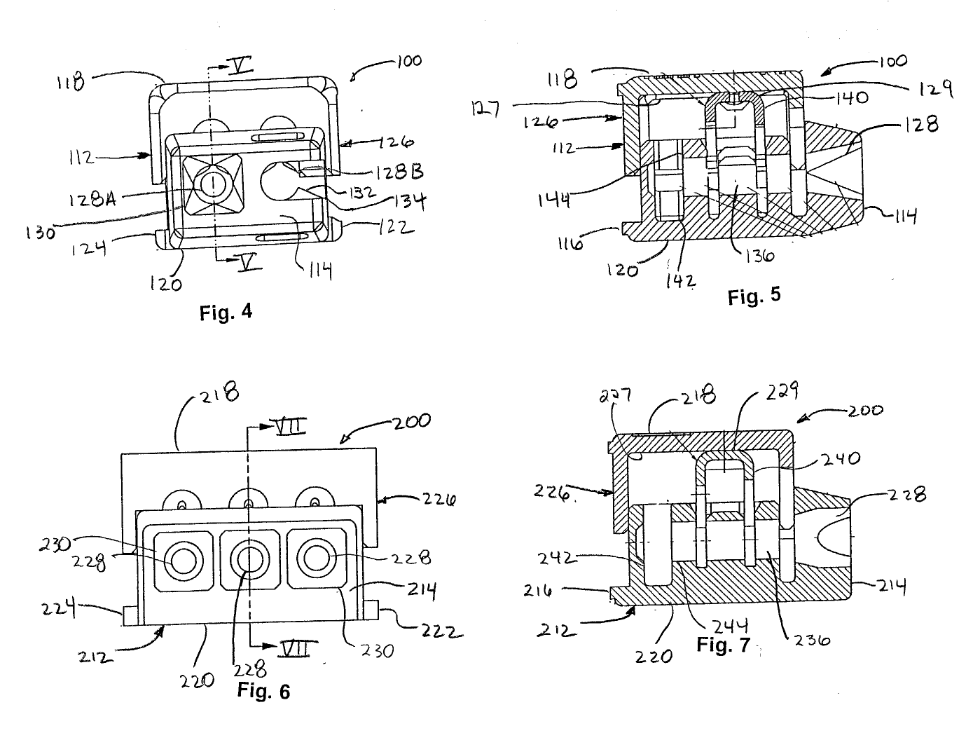

FIG. 4 illustrates an elevational view of another embodiment of the telsplice connector, generally designated 100. In this embodiment, the telsplice connector 100 has a housing 112 and includes opposing upper and lower surfaces 118 and 120, first and second engagement surfaces 114 and 116 and opposing side surfaces 122 and 124 similar to the telsplice connector 10. However, in this embodiment, the telsplice connector 100 defines two openings 128 in first engagement surface 114 adapted to receive cabling. Opening 128A has a four-pronged indent 130, while first engagement surface 114 defines a cut 132 in side 134 proximate to and fluidly engaging second opening 128B.

FIG. 5 illustrates an elevational cross-sectional view of the telsplice connector 100 of FIG. 4 taken along lines V-V. In the illustrated embodiment, the housing 112 defines an interior channel 136, which fluidly connects or communicates with openings 128. The interior channel 136 is adapted to receive the electrical cable therein through the opening 128.

The telesplice connector 100 further includes a crimping device 140, adapted to secure the electrical cable in interior channel 136. The crimping device 140 in this embodiment is placed adjacent to the interior channel 136 so that an upper portion 129 of the crimping device 140 is engaged by a lower surface 127 of the engaging portion 126. A connecting device or plate 142 is illustrated adjacent to the distal end 144 of channel 136. The connecting plate 142 is adapted to make an electrical connection between the one or more cables placed in the channel 136.

FIG. 6 illustrates an elevational view of yet another embodiment of the telsplice connector, generally designated 200, similar to the telsplice connectors 10 and 100 illustrated in FIGS. 1-5. In this embodiment, the telsplice connector 200 has housing 212 and includes opposing upper and lower surfaces 218 and 220, first and second engagement surfaces 214 and 216 and opposing side surfaces 222 and 224 similar to the telsplice connectors 10 and 100. In this embodiment, the telsplice connector 200 defines three openings 228 adapted to receive the cabling. More particularly, first engagement surface 214 defines the openings 228, each opening having a corresponding indent 230.

FIG. 7 illustrates an elevational cross-sectional view of the telsplice connector 200 of FIG. 6 taken along lines VII-VII. In the illustrated embodiment, the housing 212 defines an interior channel 236, which fluidly connects or communicates with each opening 228. The interior channel 236 is adapted to receive the electrical cable therein.

The telesplice connector 200 further includes a crimping device 240, adapted to secure an electrical cable in channel 236. The crimping device 240 in this embodiment is placed adjacent to the channel 236 so that the upper portion 229 of the crimping device 240 is engaged by the lower surface 227 of the engaging portion 226. A connecting device or plate 242 is illustrated adjacent the distal end 244 of channel 236. The connecting plate 242 is adapted to make an electrical connection between the one or more cables placed in the channel 236.

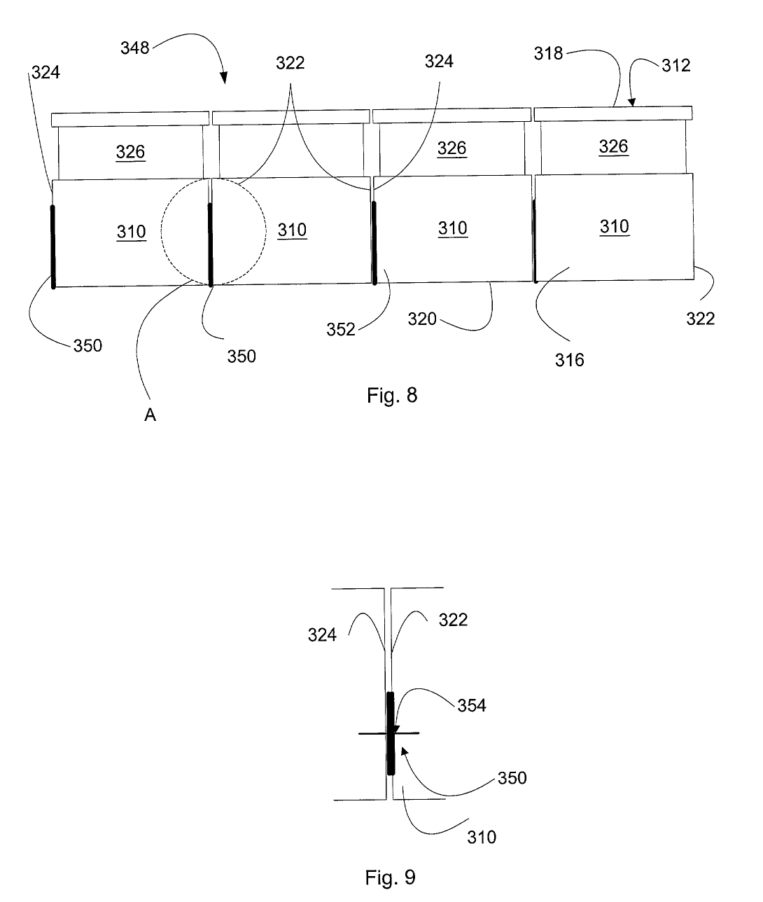

FIG. 8 illustrates one embodiment of a telsplice stick 348 in accordance with one embodiment of the present invention. In this embodiment, the telsplice stick 348 comprises at least two telsplice connectors 310 removably connected together. More specifically, in this embodiment a plurality of telsplice connectors 310 are removably connected or joined together by an ultrasound weld 350 forming the telsplice stick 348.

In one embodiment, the ultrasound weld 350 is placed at a lower outer corner 352 of one opposing side surface of each connector 310. It should be appreciated that other embodiments are contemplated. For example, the telsplice connecters 310 could be ultrasonically welded at a lower-inner or upper-outer corner for example. The weld 350 is adapted to join or connect at least one opposing side surface of each telsplice connector 310 to one opposing side surface of an adjacent telsplice connector 310 in a removable manner.

FIG. 9 illustrates an enlarged portion A of the weld section of the telsplice stick FIG. 8 as illustrated. In this embodiment, weld 350 is T-welded as is well known in the art. This weld is strong enough to hold the connectors together during shipping and insertion in the crimping tool but is sufficiently weak to break upon engagement by the crimping device.

It should be appreciated that many different materials are contemplated for the housing. In one embodiment, the telsplice connector housing is formed from a nonconductive material selected from a group consisting of polycarbonate, polyester and polypropylene. However, it should be appreciated that the telsplice connectors may be formed of all one material or different materials. For example, the housing may be made of polyester (or even metal) but covered by a polycarbonate film. Furthermore, the crimping portion may be made of polypropylene, but the remaining portion of the telsplice connector may be made of polycarbonate, depending on the application. Additionally, one or more connectors in the telsplice stick may be made of one nonconductive material, polyester for example, while the remaining telsplice connectors are made of different materials.

While particular elements, embodiments and applications of the present invention have been shown and described, it will be understood, of course, that the invention is not limited thereto since modifications may be made by those skilled in the art, particularly in light of the foregoing teachings. It is therefore contemplated by the appended claims to cover such modifications as incorporate those features that which come within the spirit and scope of the invention.

1. A telsplice connector comprising:
a housing defining an interior channel and having two opposing sides; and
a crimping device movably positioned inside said housing and adapted to secure at least one electrical cable in said channel;
wherein the telsplice connector is adapted to be removable connected to at least one other telsplice connector by an ultrasonic weld.

2. The telsplice connector of claim 1, wherein the telsplice connector is adapted to be removably connected to said at least one other connector on one of said two opposing sides.

3. The telsplice connector of claim 1, wherein said housing is formed of a nonconductive material.

4. The telsplice connector of claim 3, wherein said housing is formed of a polycarbonate material.

5. The telsplice connector of claim 3, wherein said housing is formed of a polyester material.

6. The telsplice connector of claim 3, wherein said housing is formed of a polypropylene material.

7. The telsplice connector of claim 3, wherein said housing is formed of at least two different materials.

8. The telsplice connector of claim 1, wherein said crimping device is positioned in said housing adjacent said channel.

9. The telsplice connector of claim 1, including a crimping portion adapted to engage said crimping device.

10. The telsplice connector of claim 9, wherein a lower surface of said crimping portion is adapted to engage an upper portion of said crimping device.

11. The telesplice connector of claim 1, wherein said housing includes opposing first and second engagement surfaces defining at least one opening fluidly communicating with said channel and adapted to receive said electrical cable.

12. The telsplice connector of claim 11, wherein said first and second engagement surfaces define a first pair of planes different from a pair of planes defined by said two opposing sides.

13. The connector of claim 9, wherein said crimping portion defines at least one opening fluidly communicating with said channel and adapted to receive said electrical cable.

14. The telsplice connector of claim 1, further including a connecting plate adjacent said channel and adapted to provide an electrical connection between electric cables received therein.

15. A telsplice stick device adapted to be connected to an electrical cabling, said device comprising:
a first connector having a housing and opposing sides; and
a second connector having a housing and opposing sides;
wherein at least one of said opposing sides of said first connector is removable connected to one of said sides of said second connector.

16. The telsplice stick device of claim 15, wherein said first and second connectors are removably connected by a weld.

17. The telsplice stick device of claim 15, wherein said first and second connectors are removably connected by an ultrasonic weld.

18. The telsplice stick device of claim 15, wherein said housings are formed of a nonconductive material.

19. The telsplice stick device of claim 18, wherein said housings are formed of a polycarbonate material.

20. The telsplice stick device of claim 18, wherein said housings are formed of a polyester material.

21. The telsplice stick device of claim 15, wherein said housings are formed of a polypropylene material.

22. The telsplice stick device of claim 15, where said first connector housing is formed of one nonconductive material and said second connector housing is formed of a second nonconductive material.

23. The telsplice stick device of claim 15, wherein a crimping device is positioned in each of said housings adjacent to a channel defined therein.

24. The telsplice stick device of claim 23, wherein said first and second connectors further include a crimping portion adapted to engage said crimping device.

25. The telsplice connector of claim 24, further including a connecting plate adjacent to said channel and adapted to provide an electrical connection between cabling received therein.

26. A telsplice stick device adapted to be connected to at least two electrical cables using a crimping device, said telsplice stick device comprising:
a plurality of connectors;
each of said connectors having opposing sides; and
wherein at least one of said opposing sides of each connector is removably connected to one of said opposing sides of a different connector by an ultrasonic weld.

27. A method for telsplicing electric cabling, the method comprising:
inserting at least one electric cabling into at least one of a plurality of telsplice connectors that form a telsplice stick; and
separating said at least one telsplice connector from said telsplice stick using a tool, wherein said cabling is telspliced.

28. The method of claim 27, wherein said plurality of telsplice connectors are removably connected to form said telsplice stick using an ultrasonic weld.
